(19) United States
(12) Patent Application Publication
(10) Pub. No.: US 2017/0353475 A1
(43) Pub. Date: Dec. 7, 2017

(54) THREAT INTELLIGENCE CLOUD

(71) Applicant: GLASSWALL (IP) LIMITED, London (GB)

(72) Inventor: SAMUEL HARRISON HUTTON, LONDON (GB)

(21) Appl. No.: 15/613,810

(22) Filed: Jun. 5, 2017

Related U.S. Application Data
(60) Provisional application No. 62/346,040, filed on Jun. 6, 2016.

(51) Int. Cl. H04L 29/06; G06Q 30/02

(52) U.S. Cl. CPC H04L 63/145; G06Q 30/0241

(57) ABSTRACT

A Threat Intelligence Cloud is disclosed. The Threat Intelligence Cloud can include a machine. A receiver on the machine can receive an electronic file including a threat detected by an anti-virus solution. A Virus Total Service can determine information from traditional anti-virus solutions scanning the electronic file. A database can store the information from the Virus Total Service. A report generator can generate a report from the information.

### RELATED APPLICATION DATA

This application claims the benefit of U.S. Provisional Patent Application Ser. No. 62/346,040, filed Jun. 6, 2016, which is incorporated by reference herein for all purposes.

This application is related to U.S. patent application Ser. No. 15/223,257, filed Jul. 29, 2016, now pending, which is a continuation of U.S. patent application Ser. No. 14/504,844, filed Oct. 2, 2014, now U.S. Pat. No. 9,516,045, issued Dec. 6, 2016, which is a continuation of U.S. patent application Ser. No. 13/438,933, filed Apr. 4, 2012, now U.S. Pat. No. 8,869,283, issued Oct. 21, 2014, which is a continuation of U.S. patent application Ser. No. 11/915,125, filed Jun. 17, 2008, now U.S. Pat. No. 8,185,954, issued May 22, 2012, which is a National State Entry of PCT Application No. PCT/GB2006/002107, filed Jun. 9, 2006, which claims priority from GB Patent Application No. 0511749.4, filed Jun. 9, 2005, all of which are incorporated by reference herein for all purposes.

This application is related to U.S. patent application Ser. No. 14/825,808, filed Aug. 13, 2015, now pending, which is a continuation-in-part of U.S. patent application Ser. No. 14/715,300 filed May 18, 2015, now abandoned, which is a divisional of U.S. patent application Ser. No. 13/899,043, filed May 21, 2013, now U.S. Pat. No. 9,034,174, issued May 19, 2015, which is a continuation of U.S. patent application Ser. No. 12/517,614, filed Feb. 5, 2010, now U.S. Pat. No. 8,533,824, issued Sep. 10, 2013, which is a National Stage Entry of PCT Application No. PCT/GB2007/004258, filed Nov. 8, 2007, which claims priority from GB Patent Application No. 0624224.2, filed Dec. 4, 2006, all of which are hereby incorporated by reference.

This application is related to U.S. patent application Ser. No. 14/504,666, filed Oct. 2, 2014, now pending, which claims priority from GB Patent Application No. 1317607.8, filed Oct. 4, 2013, both of which are incorporated by reference.

This application is related to U.S. patent application Ser. No. 15/082,791, filed Mar. 26, 2016, now pending, which is a continuation of U.S. patent application Ser. No. 14/600,431, filed Jan. 20, 2015, now U.S. Pat. No. 9,330,264, issued May 3, 2016, which claims the benefit of U.S. Provisional Patent Application Ser. No. 62/084,832, filed Nov. 26, 2014, now expired, all of which are hereby incorporated by reference.

### FIELD

The inventions relate generally to detecting electronic threats, and more particularly to providing information comparing various threat detection technologies.

### BACKGROUND

Traditional anti-virus technologies operate using signatures. As threats are identified, signatures for these threats are generated. These signatures are stored in databases accessed by the anti-virus software applications, which can then scan files to determine whether the files are infected with any threats.

Because new threats are being identified on a daily basis, the signature databases continue to grow. This fact means that the anti-virus software applications must routinely download updates for the signature databases to remain current and effective.

But different anti-virus software applications update their signature databases at different rates. This fact means that some anti-virus software applications will be able to detect certain threats sooner than traditional anti-virus software applications. Particularly with respect to newly identified threats, the speed at which new threats are added to the anti-virus software applications is critical to protecting computer systems.

A need remains for a way to compare the performance of various anti-virus software applications.

### BRIEF DESCRIPTION OF THE DRAWINGS

FIG. 1 shows details of a traditional anti-virus solution.

FIG. 2 shows details of an improved anti-virus solution.

FIG. 3 shows the anti-virus solutions of FIGS. 1 and 2 identifying a threat in an electronic file.

FIG. 4 shows a machine designed to use a Virus Total Service to compare the performance of the anti-virus solution of FIG. 2 with the traditional anti-virus solutions of FIG. 1, according to an embodiment of the invention.

FIG. 5 shows additional details of the machine of FIG. 4.

FIG. 6 shows the Virus Total Service of FIG. 4 determining if the traditional anti-virus solutions of FIG. 1 can detect the threat in the electronic file of FIG. 3.

FIG. 7 the operation of the report generator of FIG. 4.

FIG. 8 shows details of the report of FIG. 7, which can be generated using the information from the database of FIG. 4.

FIGS. 9A-9E show alternative presentations of the report of FIG. 7.

FIGS. 10A-10D show a flowchart of a procedure for using the Virus Total Service of FIG. 4 to compare the performance of anti-virus solutions, according to an embodiment of the invention.

FIG. 11 shows details of how the electronic file can be prepared before delivery to the Virus Total Service of FIG. 4, according to an embodiment of the invention.

### DETAILED DESCRIPTION

Reference will now be made in detail to embodiments of the invention, examples of which are illustrated in the accompanying drawings. In the following detailed description, numerous specific details are set forth to enable a thorough understanding of the invention. It should be understood, however, that persons having ordinary skill in the art can practice the invention without these specific details. In other instances, well-known methods, procedures, components, circuits, and networks have not been described in detail so as not to unnecessarily obscure aspects of the embodiments.

It will be understood that, although the terms first, second, etc. can be used herein to describe various elements, these elements should not be limited by these terms. These terms are only used to distinguish one element from another. For example, a first module could be termed a second module, and, similarly, a second module could be termed a first module, without departing from the scope of the invention.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

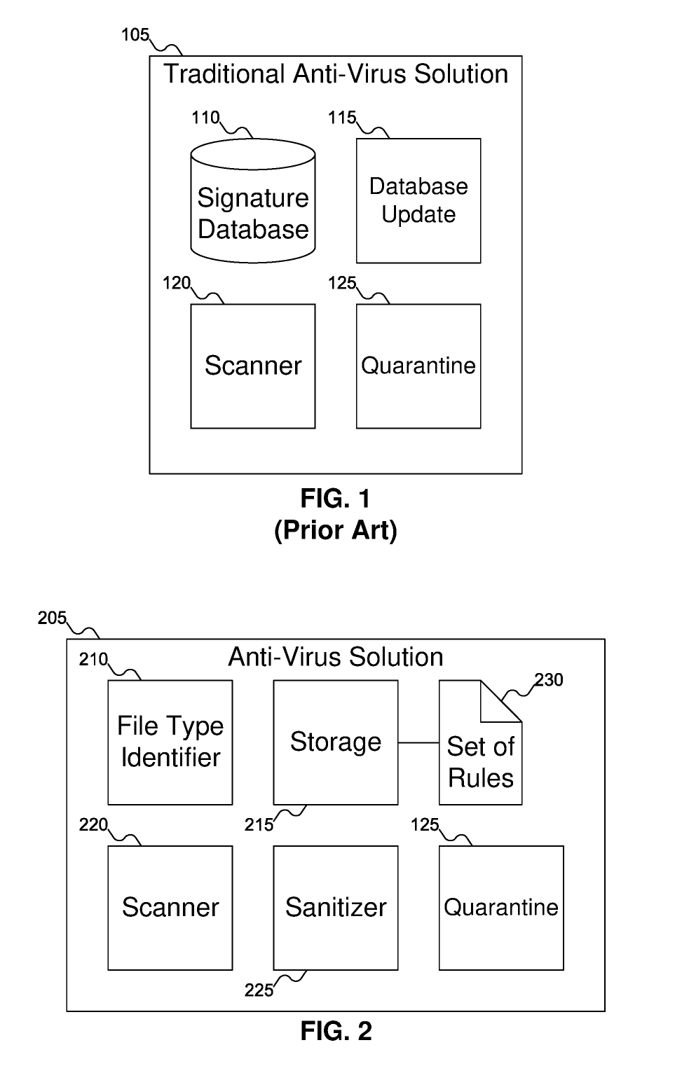

Traditional anti-virus programs operate by examining a file for malicious content. More particularly, traditional anti-virus programs examine the file for signatures of known viruses. But as the number of viruses increases, the number of signatures that must be searched for in the file only grows. Further, while heuristics provide some level of protection against viruses not yet known to the anti-virus developers, that protection cannot be assumed to be complete. There is always the possibility that a new virus can be designed that does not exhibit any characteristics that might be detected by the heuristics. FIG. 1 shows details of such a traditional anti-virus solution. In FIG. 1, traditional anti-virus solution 105 is shown. Traditional anti-virus solution 105 can include signature database 110, database update 115, scanner 120, and quarantine 125. Signature database 110 can store signatures of viruses that can be recognized by traditional anti-virus solution 105. Database update 115 can update signature database 110 with new virus signatures. Scanner 120 can scan a file to see if any recognized viruses can be detected in the file, based on the virus signatures in signature database 110. And quarantine 125 can store a file that has recognized threats, to permit the user to later attempt to remove the threat from the file.

New viruses are emerging on a daily basis. Once the viruses are recognized and their signatures identified, signature database 110 needs to be updated to reflect the new threat. These facts lead to several problematic conclusions.

First, if signature database 110 is not updated frequently, then traditional anti-virus solution 105 becomes out-of-date. If traditional anti-virus solution 105 becomes out-of-date, then traditional anti-virus solution 105 cannot protect the user against the latest threats. Therefore, the user must make sure that signature database 110 is updated as frequently as possible.

Second, newer threats are a greater concern than older threats, since they are more likely to get through a user's defense. But just because older threats are better known does not mean that these threats can be ignored: older threats can do just as much damage to a user's system as newer threats. Signature database 110 cannot eliminate signatures of older threats without risking the user's system being successfully attached. Therefore, signature database 110 only grows in size: it does not shrink in size (absent an improvement in data compression).

Third, an important point in the operation of traditional anti-virus solution 105 is that traditional anti-virus solution 105 can only protect against known viruses. Until the virus is recognized and its signature added to signature database 110, traditional anti-virus solution 105 cannot protect the user against the virus. Such attacks, known as zero-day threats, are a real problem for traditional anti-virus solution 105: it cannot protect against a threat it does not know about. And while heuristic algorithms provide a measure of protection against new threats that are not yet recognized by signature database 110, heuristic algorithms are by no means perfect.

U.S. patent application Ser. No. 15/223,257, filed Jul. 29, 2016, now pending, which is a continuation of U.S. patent application Ser. No. 14/504,844, filed Oct. 2, 2014, now U.S. Pat. No. 9,516,045, issued Dec. 6, 2016, which is a continuation of U.S. patent application Ser. No. 13/438,933, filed Apr. 4, 2012, now U.S. Pat. No. 8,869,283, issued Oct. 21, 2014, which is a continuation of U.S. Pat. No. 11/915,125, filed Jun. 17, 2008, now U.S. Pat. No. 8,185,954, issued May 22, 2012, which is a National Stage Entry of PCT Patent Application No. PCT/GB2006/002107, filed Jun. 9, 2006, all of which are incorporated by reference, describes how a file can be examined before it is delivered to a recipient. In contrast to traditional anti-virus solution 105, the approach of this anti-virus solution does not look for signatures of known viruses or heuristics of potential viruses. Instead, this approach works by developing a set of rules that reflects what a file of a particular type should look like. Put another way, this approach works by identifying electronic files that are known to be good, rather than identifying malicious (“bad”) content in the electronic file.

The approach starts by determining the type the file is supposed to be (the purported file type). This can be done in a number of different ways. For example, the extension of the file often identifies the purported file type: if the file extension is .PDF, the file is most likely a file in the Adobe® PDF file format, whereas if the file extension is .DOC, the file is most likely a file in the Microsoft® Word file format. (Adobe and PDF are either registered trademarks or trademarks of Adobe Systems Incorporated in the United States and/or other countries. Microsoft is either a registered trademark or trademark of Microsoft Corporation in the United States and/or other countries.) Another way to determine the purported file type is to examine the file. Some file formats include the type of the file as data (either textual or digital) within the file itself.

Once the purported file format has been determined, a set of rules associated with that file format can be identified. The set of rules specifies how the file should be formatted and its content organised. If a file does not conform to the set of the rules for the purported file type, then it is possible that the file includes malicious content.

The set of rules can also specify that certain content elements in a file can be malicious, even content elements that can conform to the rules for the file type. For example, files in the Microsoft Word file format can include macros. But macros can also be malicious. Thus, the set of rules can specify that a macro, even if it conforms to the rules for the file format, is considered potentially malicious.

Once a file has been examined, the file can be sanitised. Sanitising the file involves eliminating the portions of the file that are not conforming, leaving only the portions of the file that conform to the rules. Note that the file as a whole is not necessarily disallowed if a portion of the file does not conform to the set of rules. For example, macros can be eliminated from a document, while the text of the document can be allowed through.

To further reduce the risk of malicious content reaching the recipient, the sanitised file can be regenerated. Regenerating the file involves recreating the file: the content that was prepared by the sender can be included, and invariant parts of the file can be created by the system. For example, the basic form of a document can be generated by the system, whereas the text of the document and its formatting can be copied from the original file to the regenerated file. In this manner, any malicious content that might be included in the invariant portions of the file are eliminated.

Once the file has been sanitised and/or regenerated, the file can be delivered to the recipient.

An advantage of this system over traditional anti-virus solutions, such as traditional anti-virus solution 105 of FIG. 1 is that there is no concern about new viruses arising for which signatures are not yet known. Since a file that includes malicious content will not conform to the rules associated with the file type, the malicious content will be blocked, regardless of whether or not a signature can be used to detect the malicious content.

FIG. 2 shows details of such an improved anti-virus solution. In FIG. 2, anti-virus solution 205 can include file type identifier 210, storage 215, scanner 220, sanitizer 225, and quarantine 125. File type identifier 210 can identify the purported file type of an electronic file. As described above, file type identifier 210 can operate based on the extension of the electronic file, by examining the contents of the file for a purported file type, or any other desired approach. In addition, file type identifier 210 can use a combination of approaches, as different file types can be identified using different techniques.

Storage 215 can store set of rules 230. For each purported file recognized by anti-virus solution 205, a different set of rules 230 can be included in storage 215. Set of rules 230 can define the conditions under which an electronic file is considered to be conforming, in which case the electronic file is considered to be free of threats.

Scanner 220 can scan the electronic file according to set of rules 230 for the purported file type of the electronic file, as determined by file type identifier 210. Scanner 220 has a similar operational objective as scanner 120 of FIG. 1: to identify malicious threats within the electronic file. But whereas scanner 120 of traditional anti-virus solution 105 of FIG. 1 scans the electronic file for signatures from signature database 110 of FIG. 1, scanner 220 of anti-virus solution 205 of FIG. 2 determines which content in the electronic file conforms to set of rules 230 and which content does not conform to set of rules 230. Because anti-virus solution 205 and traditional anti-virus solution 105 of FIG. 1 operate using very different principles, scanner 120 in traditional anti-virus solution 105 of FIG. 1 cannot be substituted for scanner 220 in anti-virus solution 205 of FIG. 2.

If any content in the electronic file is determined to be non-conforming—that is, if any content in the electronic file does not satisfy set of rules 230 (either one individual rule or a subset of set of rules 230, depending on how set of rules 230 is defined)—then that non-conforming content can be sanitized from the electronic file. For example, for a Microsoft Word document, one rule in set of rules 230 might be “No macros permitted”. If a particular electronic file is found to include a macro, the macro itself can be considered non-conforming content, while the rest of the electronic file can be considered conforming content. Sanitizer 225 can sanitize the electronic file by removing the non-conforming content from the electronic file, while leaving the conforming content in place. As an alternative or in addition to sanitizer 225, anti-virus solution 205 can include a regenerator (not shown in FIG. 2) that can regenerate the electronic file. Regenerating the electronic file can involve constructing a new file that has the same (conforming) content as the original file, but built “from the ground up” rather than by modifying the original electronic file. Regeneration can be useful in some situations: for example, where removing non-conforming content might leave the original electronic file in a potentially unstable state, or when it can be difficult to determine where the conforming content ends and the non-conforming content begins, or when the electronic file would benefit from restructuring. For example, some file types define sections for the file that are expected to be found in a particular order, or to not include unnecessary sections. Removing non-conforming content might leave the file sections in the wrong order, or might leave an unnecessary file section in place. Regenerating the electronic file, on the other hand, would produce an electronic file whose stability is predictable.

Quarantine 125, as with quarantine 125 of FIG. 1, can store a file that has recognized threats, to permit the user to later attempt to remove the threat from the file, and which cannot be sanitized by sanitizer 225.

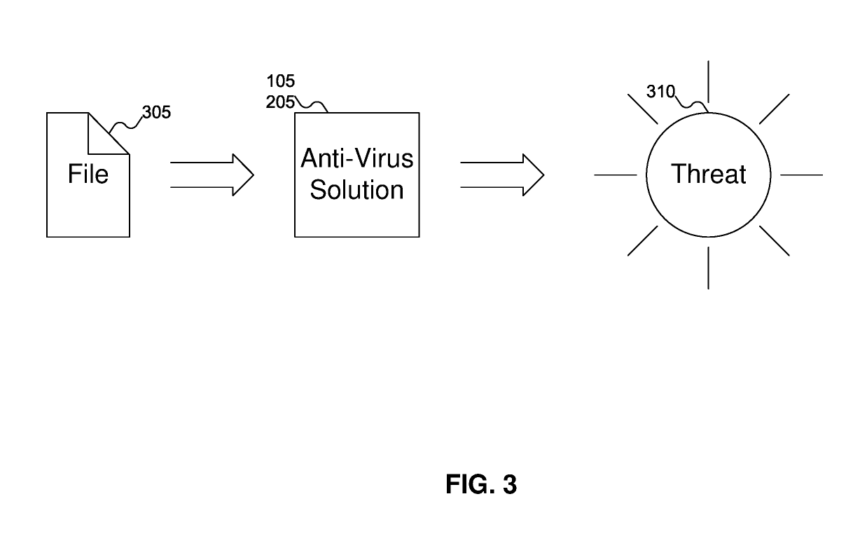

FIG. 3 shows anti-virus solutions 205 of FIGS. 2 and 105 of FIG. 1 identifying a threat in an electronic file. As described above, anti-virus solution 205 of FIG. 2, at a high level, performs a similar function to anti-virus solution 105 of FIG. 1, although the two solutions use different internal operation. Given electronic file 305, anti-virus solutions 205 and 105 can scan electronic file 305 to determine whether threat 310 is present. The question is when each anti-virus solution 205 and 105 can identify threat 310 in electronic file 305 (or even if they can detect threat 310 in electronic file 305).

Returning to FIG. 2, anti-virus solution 205 has several technical advantages as compared with traditional anti-virus solution 105 of FIG. 1. First, the only updates required are to set of rules 230, and only when those rules change. Since set of rules 230 defines conforming content rather than identifying malicious threats, set of rules 230 only requires update when the rules regarding a particular file format change. Such changes might occur when a new version of the application program that uses that file type is released, or perhaps when the application undergoes at least an update. But such changes happen relatively infrequently, which means that anti-virus solution 205 does not require frequent update to set of rules 230 to avoid anti-virus solution 205 becoming out-of-date.

Second, because updates to set of rules 230 happen relatively infrequently (as compared with updates to signature database 110 of FIG. 1), the space required to store set of rules 230 does not grow substantially over time. In addition, older sets of rules 230 can be deleted, freeing up unneeded storage. For example, if a user has upgraded from one version of an application to another and the new version of the application uses a different file format, the set of rules governing the older file format might not be needed (the new version of the application might not be able to read such files, for example). In that case, the older set of rules do not need to be retained. Nor does deleting older sets of rules weaken the security of the system. Deleting older sets of rules means that certain files that were previously considered conforming will no longer be recognized, enhancing security (and newly received files using the older file type will be considered non-conforming, preventing infiltration of malicious content using the older file type).

Finally, unlike traditional anti-virus solution 105 of FIG. 1, anti-virus solution 205 can block zero-day threats. Zero-day threats will appear as non-conforming content in the electronic file 305 of FIG. 3. Since non-conforming content is detected and blocked, zero-day threats will be blocked from affecting the user's system. The fact that the threat has not been previously identified and its signature determined becomes irrelevant.

But while anti-virus solution 205 can detect and block zero-day threats, it is not readily apparent how superior anti-virus solution 205 is as compared with traditional anti-virus solution 105 of FIG. 1. Regardless of how true the statement might be, it would seem self-serving for a retailer to assert that anti-virus solution 205 can detect and block zero-day threats better than traditional anti-virus solution 105 of FIG. 1 without any evidence to support that assertion. Nor is it necessarily easy to assert to a customer that anti-virus solution 205 blocked zero-day threats that traditional anti-virus solutions would not have detected, without evidence to support such that assertion.

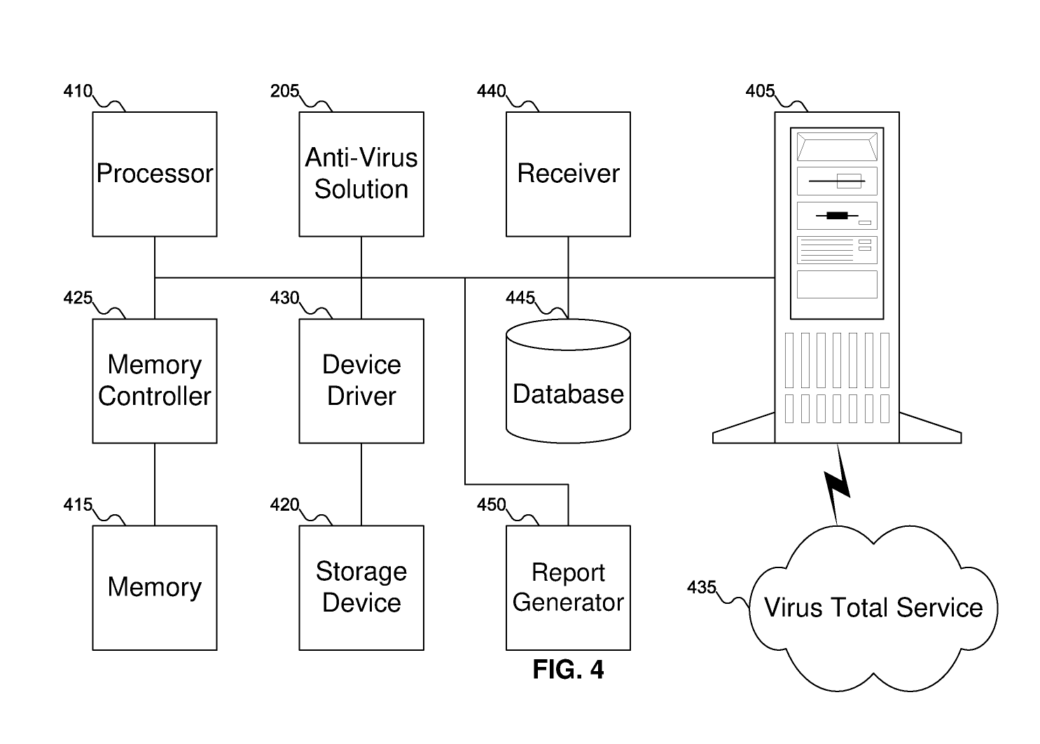

FIG. 4 shows a machine designed to use a Virus Total Service to compare the performance of anti-virus solution 205 of FIG. 2 with traditional anti-virus solutions 105 of FIG. 1, according to an embodiment of the invention. In FIG. 4, machine 405 is shown. Machine 405 can be any desired machine, including without limitation a desktop or laptop computer, a server (either a standalone server or a rack server), or any other device that can benefit from embodiments of the invention. Machine 405 can also include specialized portable computing devices, tablet computers, smartphones, and other computing devices. Machine 405 can run any desired applications: database applications are a good example, but embodiments of the invention can extend to any desired application.

Machine 405, regardless of its specific form, can include processor 410, memory 415, and storage device 420. Processor 410 can be any variety of processor: for example, an Intel Xeon, Celeron, Itanium, or Atom processor, an AMD Opteron processor, an ARM processor, etc. While FIG. 4 shows a single processor, machine 405 can include any number of processors, or multi-core processors. Memory 415 can be any variety of memory, such as flash memory, Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc., but is typically DRAM. Memory 415 can also be any desired combination of different memory types. Memory 415 can be controlled by memory controller 425, also part of machine 405.

Storage device 420 can be any variety of storage device, such as a hard disk drive, a Solid State Drive (SSD), or any other variety of storage. Storage device 420 can be controlled by device driver 430 appropriate to the type of storage device, and which can be resident in memory 415.

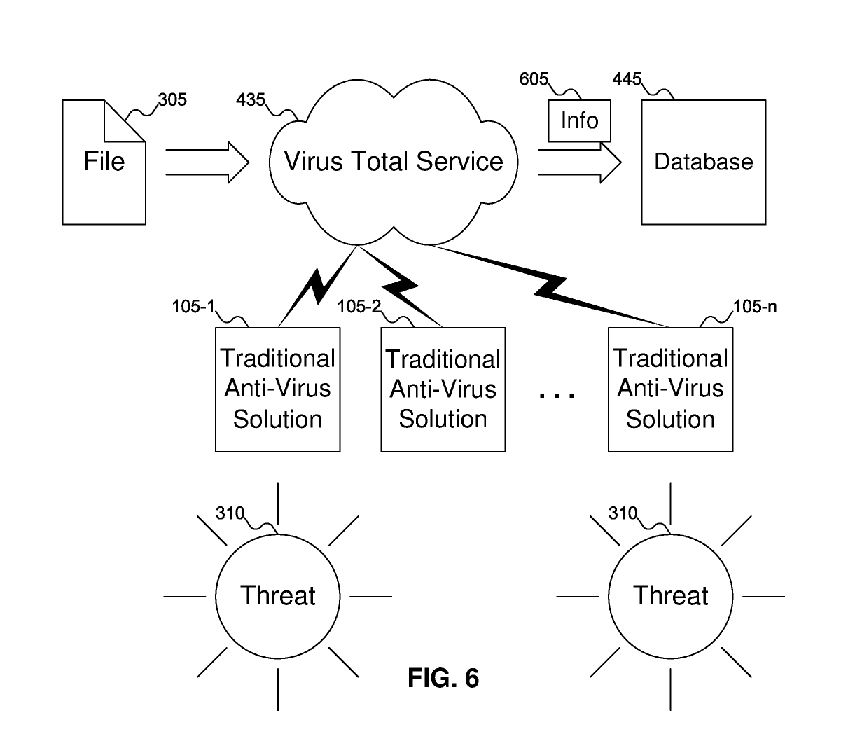

To support operation of the invention, embodiments of the invention can have machine 405 connected to Virus Total Service 435. Virus Total Service 435 can test an electronic file 305 of FIG. 3 against various traditional anti-virus solutions 105 of FIG. 1 to determine which, if any, of the traditional anti-virus solutions are capable of detecting a threat in electronic file 305 of FIG. 3. Virus Total Service 435 is described further with reference to FIG. 6 below. Virus Total Service 435 can be components included within machine 405 or can be accessible via a connection, either from a second machine directly connected to machine 405 or accessible via a network (not shown in FIG. 4).

Machine 405 can also include anti-virus solution 205, receiver 440, database 445, and report generator 450. Anti-virus solution 205 can be as described above, with the ability to determine whether electronic file 305 of FIG. 3 conforms to set of rules 230 of FIG. 2. Receiver 440 can receive an electronic file from a source, which can be delivered to anti-virus solution 205. Additionally or alternatively, receiver 440 can receive electronic file 305 of FIG. 3 from anti-virus solution 205 for testing with Virus Total Service 435 (for example, if machine 405 is not the machine on which anti-virus solution 205 is installed). In the case where Virus Total Service 435 is only connected to machine 405 and not part of machine 405, machine 405 can also include a transmitter (not shown in FIG. 4) to transmit electronic file 305 of FIG. 3 to Virus Total Service 435. Database 445 can store information received from Virus Total Service 435 regarding the performance of various traditional anti-virus solutions 105 of FIG. 1 against electronic file 305 of FIG. 3. Report generator 450 can take information from database 445 and generate reports for customers or marketers, comparing the performance of anti-virus solution 205 with traditional anti-virus solutions 105 of FIG. 1.

Machine 405, including processor 410, memory 415, storage device 420, memory controller 425, device driver 430, receiver 440, database 445, and report generator 450, along with a connection to Virus Total Service 435, make up the Threat Intelligence Cloud. In addition, a subset of these components can suffice in embodiments of the invention or additional components can be added, depending on appropriate need. For example, database 445 may be omitted if there is no need to store information from Virus Total Service 435, or receiver 440 can be omitted if Virus Total Service 435 is included as part of machine 405.

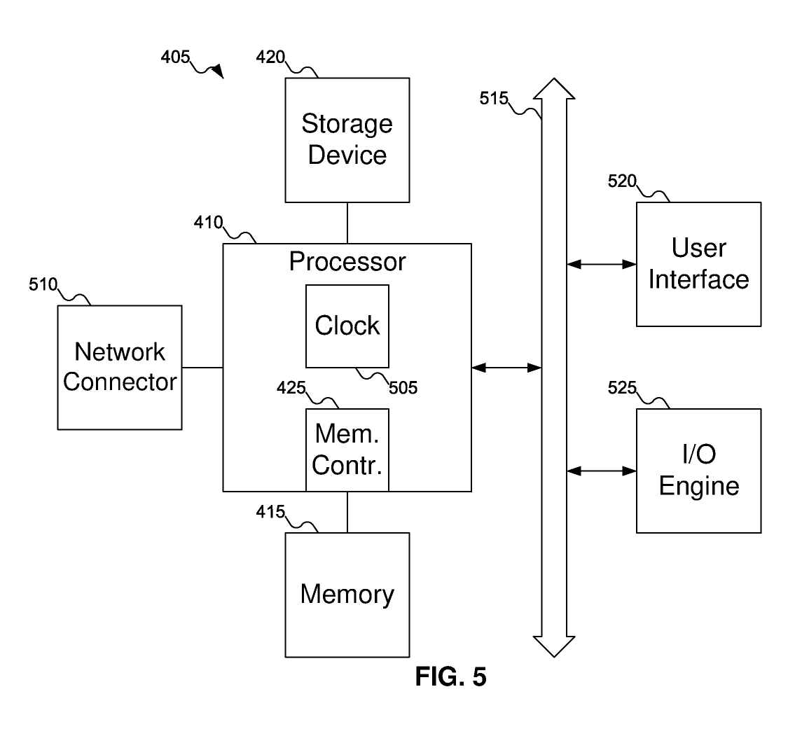

FIG. 5 shows additional details of machine 405 of FIG. 4. Referring to FIG. 5, typically, machine 405 includes one or more processors 410, which can include memory controller 425 and clock 505, which can be used to coordinate the operations of the components of machine 405. Processors 410 can also be coupled to memory 415, which can include random access memory (RAM), read-only memory (ROM), or other state preserving media, as examples. Processors 410 can also be coupled to storage devices 420, and to network connector 510, which can be, for example, an Ethernet connector or a wireless connector. Processors 410 can also be connected to a bus 515, to which can be attached user interface 520 and Input/Output interface ports that can be managed using Input/Output engine 525, among other components.

FIG. 6 shows Virus Total Service 435 of FIG. 4 determining if traditional anti-virus solutions 105 of FIG. 1 can detect the threat in electronic file 305 of FIG. 3. In FIG. 6, Virus Total Service 435 can receive electronic file 305. Virus Total Service 435 can arrange for electronic file 305 to be scanned by each traditional anti-virus solution 105-1 through 105-n. Each of traditional anti-virus solutions 105-1 through 105-n can be a different anti-virus solution, enabling comparison of anti-virus solution 205 of FIG. 4 with any number of traditional anti-virus solutions 105-1 through 105-n.Therefore, each of traditional anti-virus solutions 105-1 through 105-n might be able to detect a threat in electronic file 305 at different times (depending on when the updates to traditional anti-virus solutions 105-1 through 105-n) added signatures for the threat in question). For example, at the point in time shown in FIG. 6, traditional anti-virus solutions 105-1 and 105-n are able to detect threat 310, but traditional anti-virus solution 105-2 is not able to detect threat 310.

Because traditional anti-virus solutions 105-1 through 105-n might be able to detect threat 310 after different updates (if at all: it is possible, however unlikely, that traditional anti-virus solution 105-2, for example, might never receive an update that would enable traditional anti-virus solution 105-2 to detect threat 310), simply testing electronic file 305 against traditional anti-virus solutions 105-1 through 105-n once might not be enough to determine how superior anti-virus solution 205 of FIG. 4 is. Put another way, it can be helpful to know how much longer it took various traditional anti-virus solutions to detect threat 310. Thus, in some embodiments of the invention, Virus Total Service 435 can test electronic file 305 against traditional anti-virus solutions 105-1 through 105-n multiple times. Virus Total Service 435 can test electronic file 305 against traditional anti-virus solutions 105-1 through 105-n as many times as desired, and at any desired interval, such as once per day.

If Virus Total Service 435 were to test electronic file 305 against traditional anti-virus solutions 105-1 through 105-n repeatedly forever, Virus Total Service 435 would end up providing an excess of information. For example, once every traditional anti-virus solution 105-1 through 105-n can successfully detect threat 310 in electronic file 305, there is no need to re-test electronic file 305 (although the possibility does exist that a later update might stop one or more of traditional anti-virus solutions 105-1 through 105-n from detecting threat 310 in electronic file 305). And at some point, even if one or more traditional anti-virus solutions 105-1 through 105-n continues to be unable to detect threat 310 in electronic file 305, such information becomes old news. Thus, in some embodiments of the invention, Virus Total Service 435 can test electronic file 305 against traditional anti-virus solutions 105-1 through 105-n during some window of time, after which Virus Total Service 435 can stop testing electronic file 305. Viewed in isolation as in FIG. 6, Virus Total Service 435 appears to test only electronic file 305. But in practice, Virus Total Service 435 can test any number of electronic files against traditional anti-virus solutions 105-1 through 105-n. Each electronic file can have a different window of testing, based on the date the electronic file was first received by Virus Total Service 145. In addition, embodiments of the invention can support different windows for different electronic files.

After testing electronic file 305 against traditional anti-virus solutions 105-1 through 105-n, Virus Total Service 435 can send information 605 to database 445. In this manner, report generator 450 of FIG. 4 can generate appropriate reports about electronic file 305.

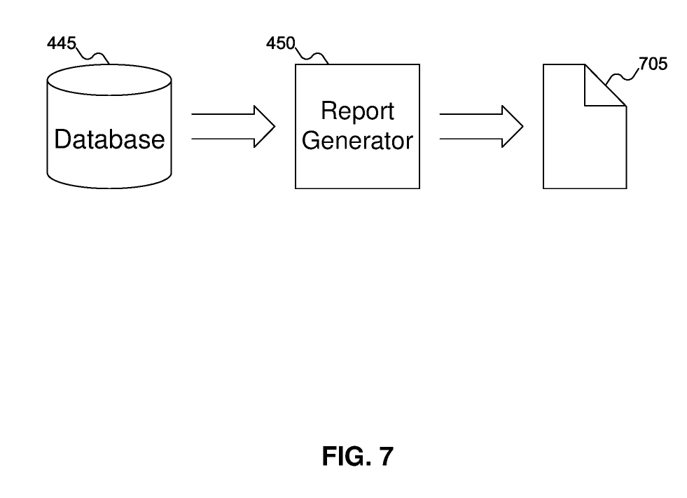

FIG. 7 the operation of report generator 450 of FIG. 4. In FIG. 7, report generator 450 can access information 605 of FIG. 6 from database 445. Report generator 450 can then turn information 605 of FIG. 6 into report 705, which can be used in any desired manner. For example, report 705 can be provided to a customer to show the customer how superior anti-virus solution 205 of FIG. 4 is as compared with traditional anti-virus solutions 105-1 through 105-n of FIG. 6. Or, report 705 can be used to market anti-virus solution 205 of FIG. 4.

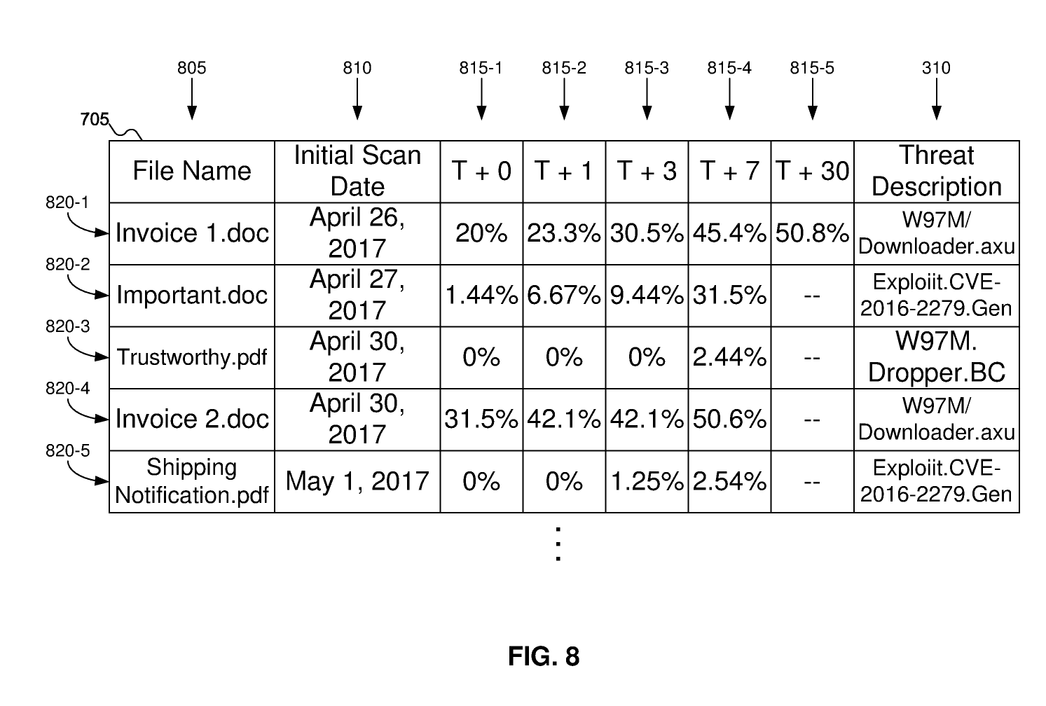

FIG. 8 shows details of report 705 of FIG. 7, which can be generated using information 605 of FIG. 6 from database 445 of FIG. 4. FIG. 8 is an example report: other reports are also possible.

In FIG. 8, report 705 is shown as including various columns. These columns include file name 805, initial scan date 810, various later dates 815-1 through 815-5, and threat description 310. Report 705 also shows various rows 820-1 through 820-5 of information. Each row 820-1 through 820-5 can describe a particular file processed by anti-virus solution 205 of FIG. 4 and subsequently submitted to Virus Total Service 435 of FIG. 6 for testing against traditional anti-virus solutions 105-1 through 105-n of FIG. 4. For example, row 820-1 indicates that a file named “Invoice 1.doc” was initially scanned on Apr. 26, 2017. Further, when tested against traditional anti-virus solutions 105-1 through 105-n of FIG. 4, on Apr. 26, 2017 (“T+0”, meaning “zero days after the initial scan”), only 20% of traditional anti-virus solutions 105-1 through 105-n were able to detect the threat “W97M/Downloader.axu”. That percentage increased to 23.3%, 30.5%, 45.4%, and 50.8% one, three, seven, and 30 days, respectively, after the initial scan on Apr. 26, 2017.

Note that rows 820-2 through 820-5 do not show any information in column 815-5. This fact can indicate, for example, that there has been no scan on day 30 after the initial scan. For example, if the current date were May 26, 2017, the current date would not be 30 days after the initial scan dates of the files shown in rows 820-2 through 820-5.

Note that report 705 includes column file name 805. File names can be considered Personally Identifiable Information (PII). In some embodiments of the invention, customers might want to prevent the release of PII. To that end, the electronic files can be “scrubbed” to eliminate any PII. For example, any information within the electronic files, including content, hidden content, and metadata, can be “scrubbed” to eliminate PII, and the file can be assigned a different name generated randomly. Or, the original electronic file might not be provided to Virus Total Service 435 of FIG. 4 at all, but instead a hash of the electronic file can be provided to Virus Total Service 435 of FIG. 4. Provided that the hash still permits traditional anti-virus solutions 105-1 through 105-n (or at least a subset of traditional anti-virus solutions 105-1 through 105-n) to successfully scan the hash for signatures of threats, the original electronic file does not need to be provided to Virus Total Service 435 at all. The hash can be generated using any desired hash algorithm.

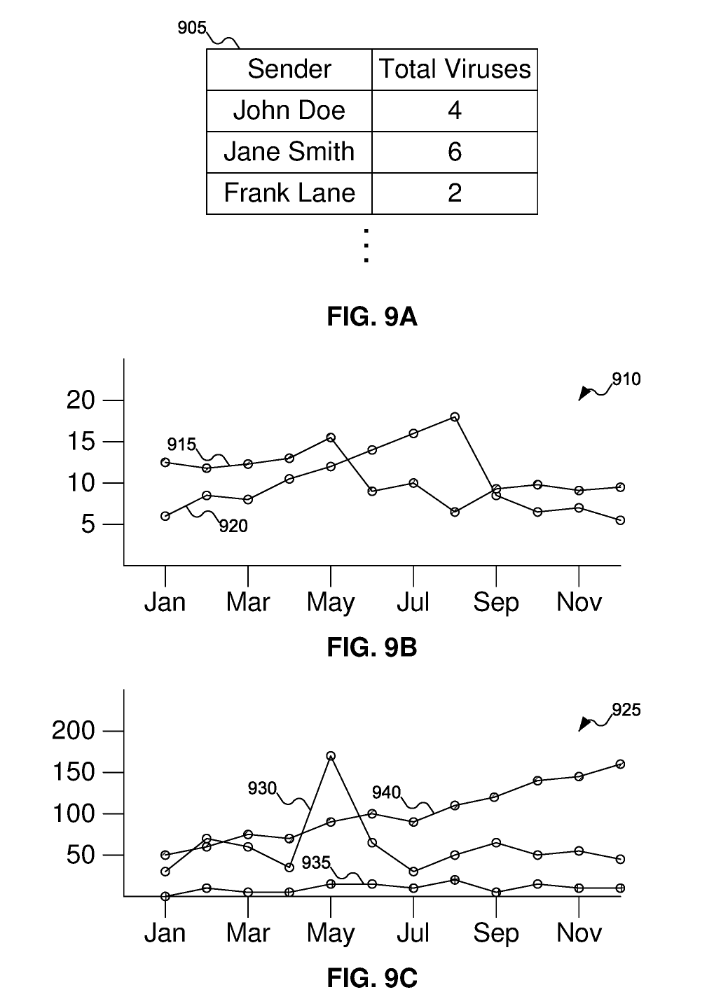

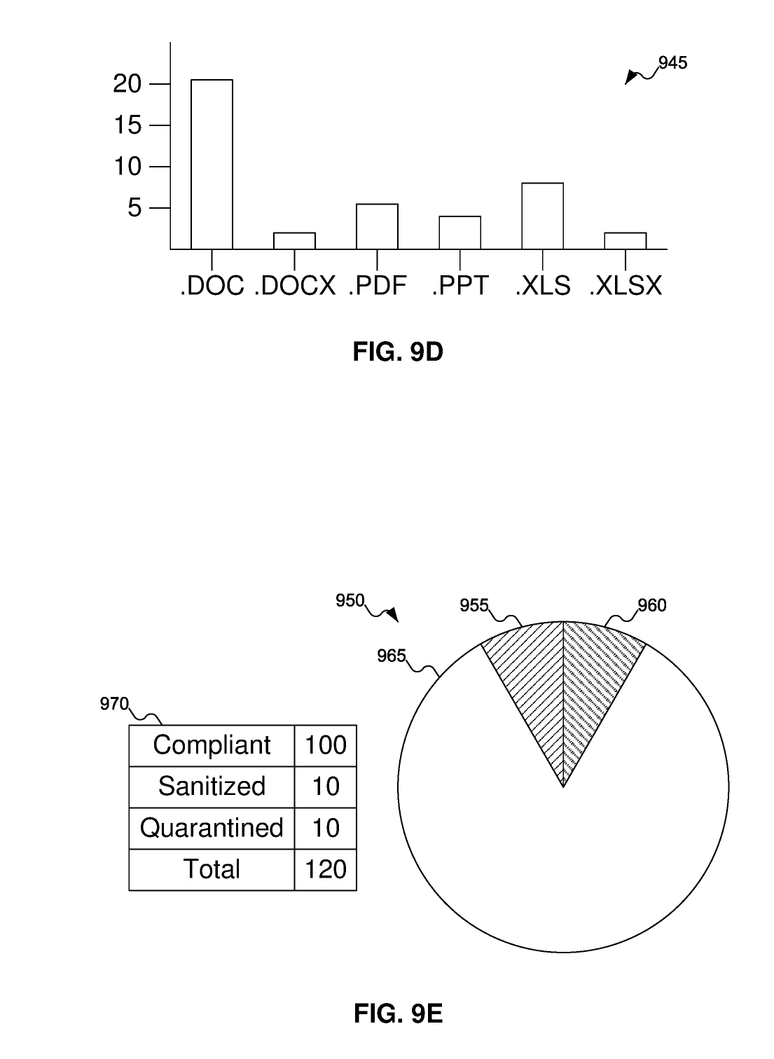

While FIG. 8 shows report 705 as a table comparing the performance of anti-virus solution 205 of FIG. 4 with traditional anti-virus solutions 105-1 through 105-n of FIG. 6, report 705 can take other forms. FIGS. 9A-9E show some alternative presentations of report 705 of FIG. 7.

In FIG. 9A, table 905 is shown. Table 905 shows various senders and the number of viruses (or other threats) included in electronic files sent by those senders. These senders can be people sending electronic files that originate from a customer's site, or other senders, as appropriate. Table 905 can show information about any number of senders: that table 905 shows information about three senders is merely exemplary.

In FIG. 9B, line chart 910 is shown. Line chart 910 shows two lines 915 and 920, indicating how many threats were received from two different sources over time. Line chart 910 can show information about any number of sources: that line chart 910 shows information about two sources is merely exemplary. Note that a legend can be included with line chart 910 if desired, or it can be omitted if the identities of the sources are considered PII.

Note that line chart 910 and table 905 of FIG. 9A are alternative ways of presenting similar information, and are interchangeable: information about how many threats were received from different sources can be presented using a table like table 905 of FIG. 9A, and information about how many threats were sent can be presented using a line chart like line chart 910.

In FIG. 9C, line chart 925 is shown. Line chart 925 shows three lines 930, 935, and 940, indicating how many threats of any particular type were received over time. For example, line 930 can show how many threats in macros were received, line 935 can show how many threats in embedded files were received, and line 940 can show how many threats in JavaScript were received. Line chart 925 can show information about any number of threat types: that line chart 925 shows information about three threat types is merely exemplary. Other types of threats that could be included in line chart 925 include malformed images and threats in Adobe Acrobat forms. (Acrobat is either a registered trademark or a trademark of Adobe Systems Incorporated in the United States and/or other countries.)

In FIG. 9D, histogram 945 is shown. Histogram 945 shows how many electronic files included threats, based on the types of the electronic files. Histogram 945 can show information about any number of file types: that histogram 945 shows information about six file types is merely exemplary.

In FIG. 9E, pie chart 950 is shown. Pie chart 950 shows the results of how electronic files were processed by anti-virus solution 205 of FIG. 4. For example, segment 955 can indicate that 10 electronic files were sanitized, segment 960 can indicate that 10 electronic files were quarantined, and segment 965 can indicate that 100 electronic files complied with the set of files appropriate to the file type of the electronic files (and thus did not require either sanitization or quarantine). Pie chart 950 can also include table 970, showing the number of files represented in each of segments 955, 960, and 965. Pie chart 950 can show information about any number of files, and can include any number of segments: that pie chart 950 shows information about 120 total files in three segments is merely exemplary.

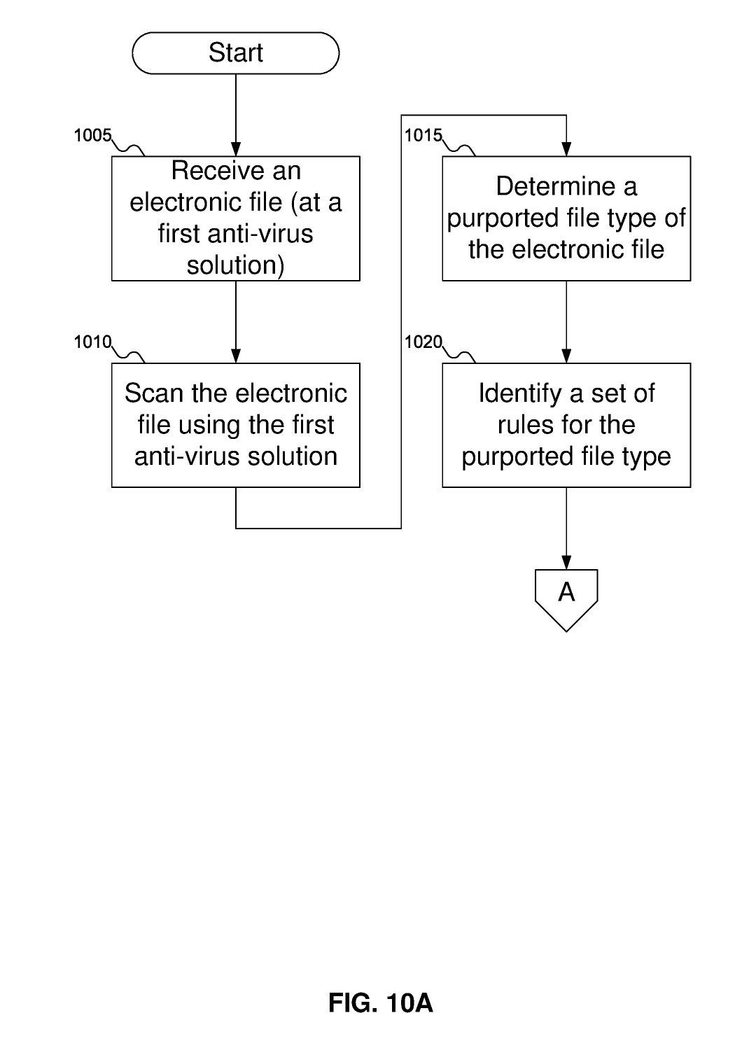

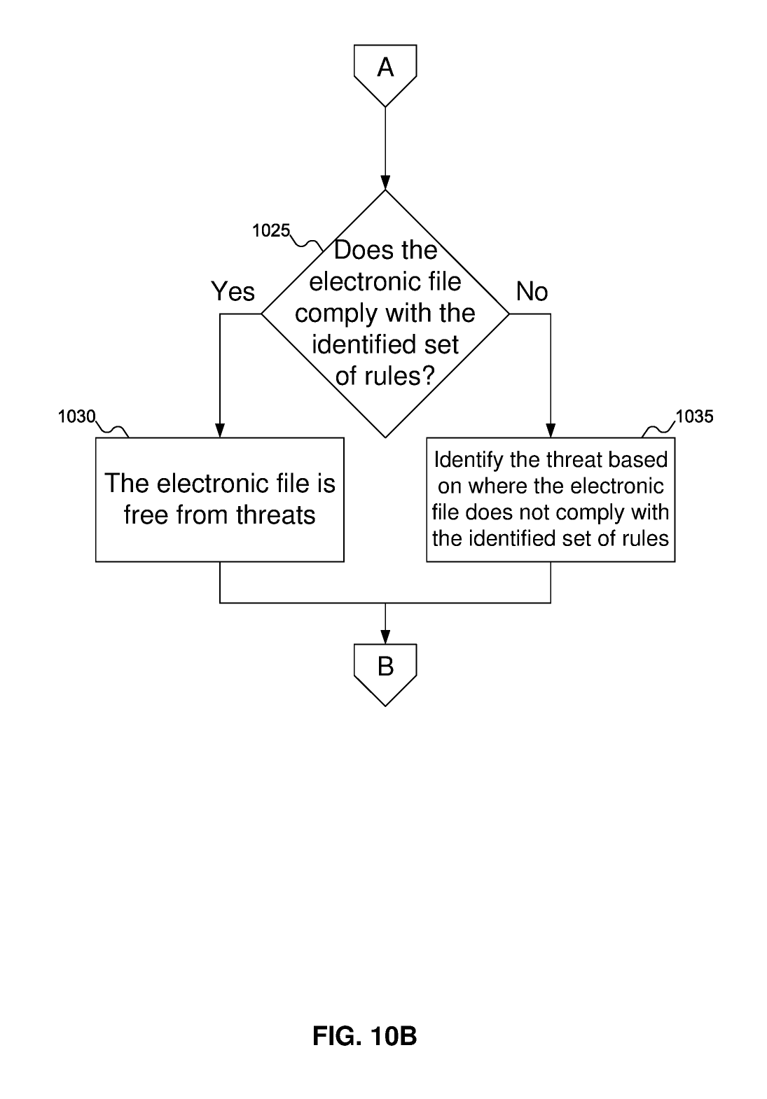

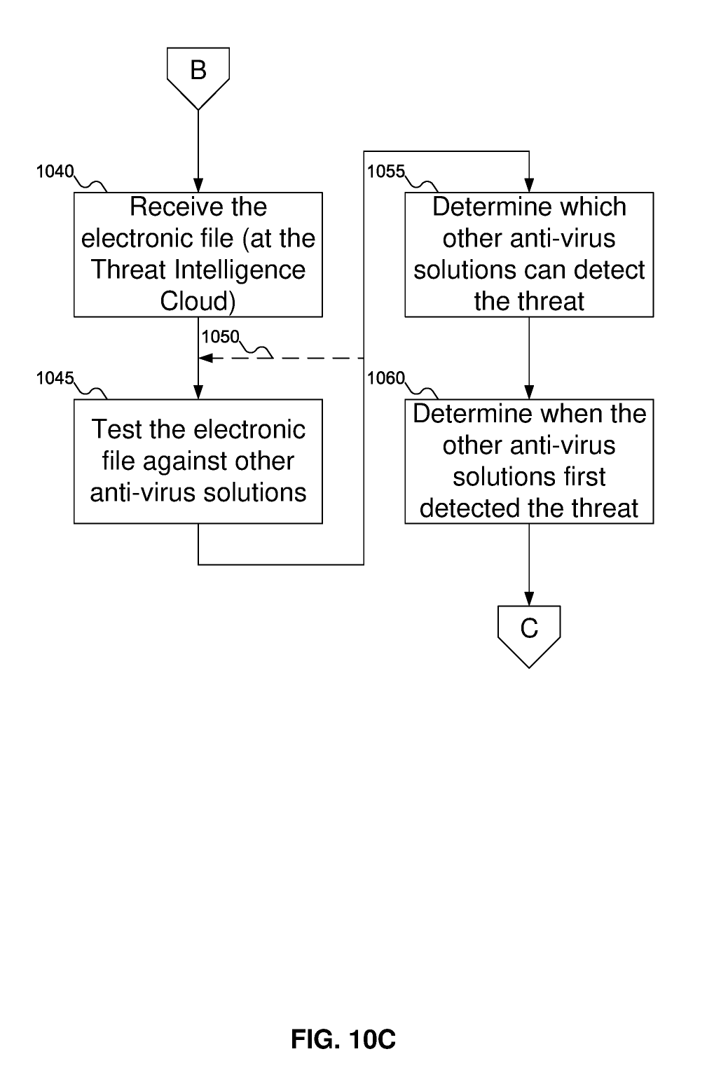

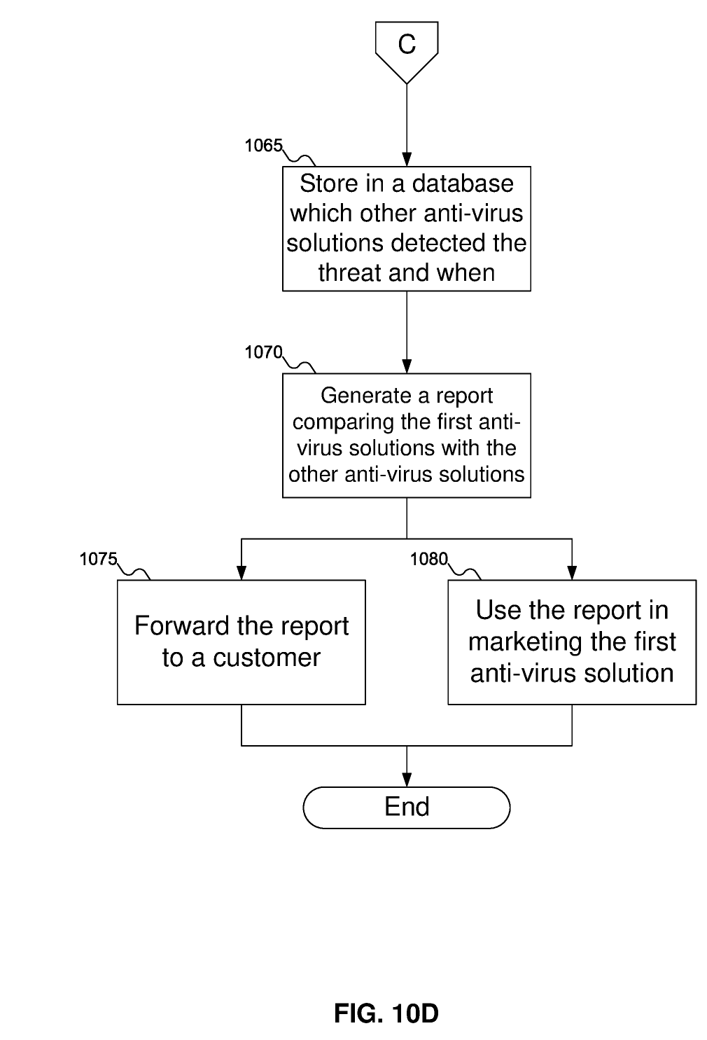

FIGS. 10A-10D show a flowchart of a procedure for using Virus Total Service 435 of FIG. 4 to compare the performance of anti-virus solutions, according to an embodiment of the invention. In FIG. 10A, at block 1005, anti-virus solution 205 of FIG. 4 can receive electronic file 305 of FIG. 3. At block 1010, anti-virus solution 205 of FIG. 4 can scan electronic file 305 of FIG. 3. At block 1015, file type identifier 210 of FIG. 2 can determine a purported file type for electronic file 305 of FIG. 3. At block 1020, anti-virus solution 205 of FIG. 4 can identify set of files 230 of FIG. 2

At block 1025 (FIG. 10B), scanner 220 of FIG. 2 can determine if electronic file 305 of FIG. 3 complies with set of rules 230 of FIG. 2. If electronic file 305 of FIG. 3 complies with set of rules 230 of FIG. 2, then at block 1030 anti-virus 205 of FIG. 4 can determine that electronic file 305 of FIG. 3 if free of threats. Otherwise, at block 1035, scanner 220 of FIG. 2 can identify threat 310 of FIG. 3 based on where electronic file 305 of FIG. 3 does not comply with set of rules 230 of FIG. 2.

Whether or not electronic file 305 of FIG. 3 is free of threats, at block 1040 (FIG. 10C), receiver 440 of FIG. 4 can receive electronic file 305 of FIG. 3. At block 1045, Virus Total Service 435 of FIG. 4 can test electronic file 305 of FIG. 3 against traditional anti-virus solutions 105-1 through 105-n of FIG. 4. Block 1045 can be performed more than once and as many times as desired/necessary, as shown by dashed line 1050. At block 1055, Virus Total Service 435 of FIG. 4 can determine which of traditional anti-virus solutions 105-1 through 105-n can detect threat 310 of FIG. 3 in electronic file 305 of FIG. 3. At block 1060, Virus Total Service 435 of FIG. 4 can determine when each of traditional anti-virus solutions 105-1 through 105-n detected threat 310 of FIG. 3 in electronic file 305 of FIG. 3.

At block 1065 (FIG. 10D), database 445 can store information 605 of FIG. 6. Information 605 of FIG. 6 can include which of traditional anti-virus solutions 105-1 through 105-n can detect threat 310 of FIG. 3 in electronic file 305 of FIG. 3, and when traditional anti-virus solutions 105-1 through 105-n detected threat 310 of FIG. 3 in electronic file 305 of FIG. 3. At block 1070, report generator 450 of FIG. 4 can generate report 705 of FIG. 7 from information 605 of FIG. 6 stored in database 445 of FIG. 4. At block 1075, report 705 can be delivered to a customer, and/or at block 1080, report 705 can be used in marketing anti-virus solution 205 of FIG. 4.

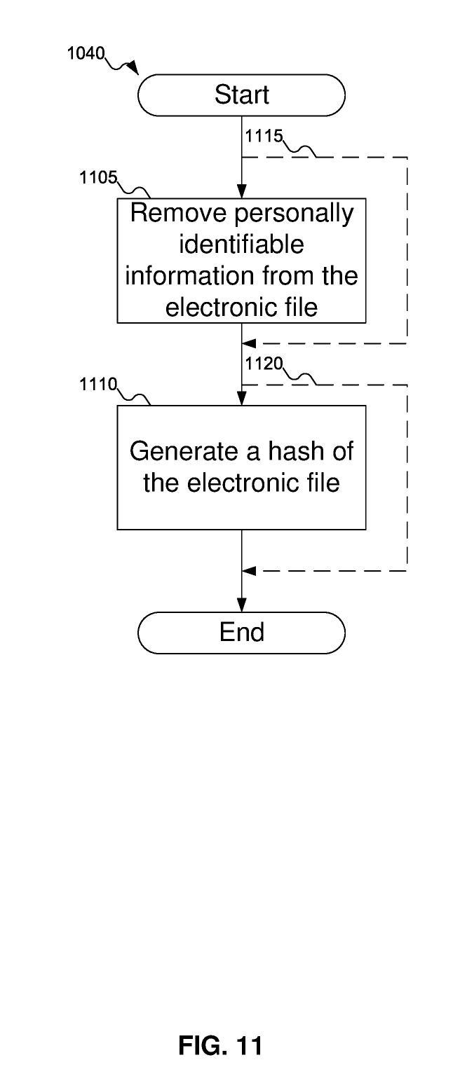

FIG. 11 shows details of how electronic file 1205 can be prepared before delivery to Virus Total Service 435 of FIG. 4, according to an embodiment of the invention. In FIG. 11, at block 1105, PII can be removed from electronic file 305 of FIG. 3. At block 1110, a hash can be generated from electronic file 305 of FIG. 3. Blocks 1105 and 1110 can be omitted as desired, as shown by dashed lines 1115 and 1120, respectively.

In FIGS. 10A-11, some embodiments of the invention are shown. But a person skilled in the art will recognize that other embodiments of the invention are also possible, by changing the order of the blocks, by omitting blocks, or by including links not shown in the drawings. All such variations of the flowcharts are considered to be embodiments of the invention, whether expressly described or not.

The following discussion is intended to provide a brief, general description of a suitable machine or machines in which certain aspects of the invention may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the invention may include a tangible, non-transitory machine-readable medium comprising instructions executable by one or more processors, the instructions comprising instructions to perform the elements of the inventions as described herein.

Having described and illustrated the principles of the invention with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

The foregoing illustrative embodiments are not to be construed as limiting the invention thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this invention as defined in the claims.

Embodiments of the invention may extend to the following statements, without limitation:

Statement 1. An embodiment of the invention includes a Threat Intelligence Cloud, comprising:

a machine;

a receiver on the machine, the receiver operative to receive an electronic file including a threat detected by a first anti-virus solution;

a Virus Total Service to determine information from a plurality of traditional anti-virus solutions responsive to the electronic file;

a database to store the information from the Virus Total Service; and

a report generator to generate a report responsive to the electronic file and the information from the Virus Total Service.

Statement 2. An embodiment of the invention includes a Threat Intelligence Cloud according to statement 1, wherein the first anti-virus solution identifies the threat as not known to be good.

Statement 3. An embodiment of the invention includes a Threat Intelligence Cloud according to statement 2, wherein the first anti-virus solution includes:

a file type identifier to determine a purported file type for the electronic file;

storage for a set of rules for the purported file type; and

a scanner to determine if the electronic file conforms to the set of rules.

Statement 4. An embodiment of the invention includes a Threat Intelligence Cloud according to statement 1, wherein the Threat Intelligence Cloud is operative to use the Virus Total Service to determine information from a plurality of traditional anti-virus solutions responsive to the electronic file a plurality of times.

Statement 5. An embodiment of the invention includes a Threat Intelligence Cloud according to statement 4, wherein the Threat Intelligence Cloud is operative to use the Virus Total Service to determine information from a plurality of traditional anti-virus solutions responsive to the electronic file the plurality of times within a window.

Statement 6. An embodiment of the invention includes a Threat Intelligence Cloud according to statement 4, wherein the Threat Intelligence Cloud is operative to use the Virus Total Service to determine information from a plurality of traditional anti-virus solutions responsive to the electronic file once a day.

Statement 7. An embodiment of the invention includes a Threat Intelligence Cloud according to statement 1, wherein the information includes which of the plurality of the traditional anti-virus solutions detects the threat in the electronic file.

Statement 8. An embodiment of the invention includes a Threat Intelligence Cloud according to statement 7, wherein the information further includes a plurality of dates on which each of the traditional anti-virus solutions detects the threat in the electronic file.

Statement 9. An embodiment of the invention includes a Threat Intelligence Cloud according to statement 1, wherein the electronic file does not include any personally identifiable information (PII).

Statement 10. An embodiment of the invention includes a Threat Intelligence Cloud according to statement 1, wherein the electronic file includes a hash of the electronic file.

Statement 11. An embodiment of the invention includes a Threat Intelligence Cloud according to statement 1, wherein the report is designed to be used to market the first anti-virus solution.

Statement 12. An embodiment of the invention includes a Threat Intelligence Cloud according to statement 1, wherein the report is designed to show to a customer a comparison of the first anti-virus solution with the traditional anti-virus solutions.

Statement 13. An embodiment of the invention includes a method, comprising:

receiving an electronic file at a Threat Intelligence Cloud, the electronic file including a threat detected by a first anti-virus solution;

testing the electronic file against a plurality of traditional anti-virus solutions by the Threat Intelligence Cloud;

determining which among the plurality of traditional anti-virus solutions identify the threat in the electronic file; and

generating a report comparing when the first anti-virus solution and the plurality of traditional anti-virus solutions identify the threat within the electronic file.

Statement 14. An embodiment of the invention includes a method according to statement 13, wherein the first anti-virus solution identifies the threat as not known to be good.

Statement 15. An embodiment of the invention includes a method according to statement 14, further comprising:

scanning the electronic file by the first anti-virus solution;

determining a purported file type of the electronic file;

identifying a set of rules specifying when the electronic file conforms to the purported file type; and

identifying the threat as not satisfying the set of rules specifying when the electronic file conforms to the purported file type.

Statement 16. An embodiment of the invention includes a method according to statement 13, wherein testing the electronic file against a plurality of traditional anti-virus solutions by the Threat Intelligence Cloud includes testing the electronic file against the plurality of traditional anti-virus solutions by the Threat Intelligence Cloud a plurality of times.

Statement 17. An embodiment of the invention includes a method according to statement 16, wherein testing the electronic file against the plurality of traditional anti-virus solutions by the Threat Intelligence Cloud a plurality of times includes testing the electronic file against the plurality of traditional anti-virus solutions by the Threat Intelligence Cloud the plurality of times within a window.

Statement 18. An embodiment of the invention includes a method according to statement 16, wherein testing the electronic file against the plurality of traditional anti-virus solutions by the Threat Intelligence Cloud a plurality of times includes testing the electronic file against the plurality of traditional anti-virus solutions by the Threat Intelligence Cloud once a day.

Statement 19. An embodiment of the invention includes a method according to statement 16, wherein determining which among the plurality of traditional anti-virus solutions identify the threat in the electronic file includes identifying when each of the plurality of traditional anti-virus solutions first detects the threat in the electronic file.

Statement 20. An embodiment of the invention includes a method according to statement 13, wherein the electronic file (305) does not include any personally identifiable information (PII).

Statement 21. An embodiment of the invention includes a method according to statement 20, wherein the PII is removed from the electronic file before the electronic file is received by the Threat Intelligence Cloud.

Statement 22. An embodiment of the invention includes a method according to statement 13, wherein receiving an electronic file at a Threat Intelligence Cloud includes receiving a hash of the electronic file at a Threat Intelligence Cloud.

Statement 23. An embodiment of the invention includes a method according to statement 13, wherein:

determining which among the plurality of traditional anti-virus solutions identify the threat in the electronic file includes storing, in a database, which among the plurality of traditional anti-virus solutions identify the threat in the electronic file; and

generating a report comparing when the first anti-virus solution and the plurality of traditional anti-virus solutions identify the threat within the electronic file includes generating the report based on the database.

Statement 24. An embodiment of the invention includes a method according to statement 13, wherein:

the report shows that the first anti-virus solution detected the threat in the electronic file before at least one of the plurality of traditional anti-virus solutions; and

the method further comprises forwarding the report to a customer.

Statement 25. An embodiment of the invention includes a method according to statement 13, further comprising using the report in marketing the first anti-virus solution.

Statement 26. An embodiment of the invention includes an article comprising a non-transitory storage medium, the non-transitory storage medium having stored thereon instructions that, when executed by a machine, result in:

receiving an electronic file at a Threat Intelligence Cloud, the electronic file including a threat detected by a first anti-virus solution;

testing the electronic file against a plurality of traditional anti-virus solutions by the Threat Intelligence Cloud;

determining which among the plurality of traditional anti-virus solutions identify the threat in the electronic file; and

generating a report comparing when the first anti-virus solution and the plurality of traditional anti-virus solutions identify the threat within the electronic file.

Statement 27. An embodiment of the invention includes an article according to statement 26, wherein the first anti-virus solution identifies the threat as not known to be good.

Statement 28. An embodiment of the invention includes an article according to statement 27, the non-transitory storage medium having stored thereon further instructions that, when executed by the machine, result in:

scanning the electronic file by the first anti-virus solution;

determining a purported file type of the electronic file;

identifying a set of rules specifying when the electronic file conforms to the purported file type; and

identifying the threat as not satisfying the set of rules specifying when the electronic file conforms to the purported file type.

Statement 29. An embodiment of the invention includes an article according to statement 26, wherein testing the electronic file against a plurality of traditional anti-virus solutions by the Threat Intelligence Cloud includes testing the electronic file against the plurality of traditional anti-virus solutions by the Threat Intelligence Cloud a plurality of times.

Statement 30. An embodiment of the invention includes an article according to statement 29, wherein testing the electronic file against the plurality of traditional anti-virus solutions by the Threat Intelligence Cloud a plurality of times includes testing the electronic file against the plurality of traditional anti-virus solutions by the Threat Intelligence Cloud the plurality of times within a window.

Statement 31. An embodiment of the invention includes an article according to statement 29, wherein testing the electronic file against the plurality of traditional anti-virus solutions by the Threat Intelligence Cloud a plurality of times includes testing the electronic file against the plurality of traditional anti-virus solutions by the Threat Intelligence Cloud once a day.

Statement 32. An embodiment of the invention includes an article according to statement 29, wherein determining which among the plurality of traditional anti-virus solutions identify the threat in the electronic file includes identifying when each of the plurality of traditional anti-virus solutions first detects the threat in the electronic file.

Statement 33. An embodiment of the invention includes an article according to statement 26, wherein the electronic file (305) does not include any personally identifiable information (PII).

Statement 34. An embodiment of the invention includes an article according to statement 33, wherein the PII is removed from the electronic file before the electronic file is received by the Threat Intelligence Cloud.

Statement 35. An embodiment of the invention includes an article according to statement 26, wherein receiving an electronic file at a Threat Intelligence Cloud includes receiving a hash of the electronic file at a Threat Intelligence Cloud.

Statement 36. An embodiment of the invention includes an article according to statement 26, wherein:

determining which among the plurality of traditional anti-virus solutions identify the threat in the electronic file includes storing, in a database, which among the plurality of traditional anti-virus solutions identify the threat in the electronic file; and

generating a report comparing when the first anti-virus solution and the plurality of traditional anti-virus solutions identify the threat within the electronic file includes generating the report based on the database.

Statement 37. An embodiment of the invention includes an article according to statement 26, wherein:

the report shows that the first anti-virus solution detected the threat in the electronic file before at least one of the plurality of traditional anti-virus solutions; and

the non-transitory storage medium has stored thereon further instructions that, when executed by the machine, result in forwarding the report to a customer.

Statement 38. An embodiment of the invention includes an article according to statement 26, the non-transitory storage medium having stored thereon further instructions that, when executed by the machine, result in using the report in marketing the first anti-virus solution.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A Threat Intelligence Cloud, comprising:
a machine;
a receiver on the machine, the receiver operative to receive an electronic file including a threat detected by a first anti-virus solution;
a Virus Total Service to determine information from a plurality of traditional anti-virus solutions responsive to the electronic file;
a database to store the information from the Virus Total Service; and
a report generator to generate a report responsive to the electronic file and the information from the Virus Total Service.

2. A Threat Intelligence Cloud according to claim 1, wherein the first anti-virus solution identifies the threat as not known to be good.

3. A Threat Intelligence Cloud according to claim 2, wherein the first anti-virus solution includes:
a file type identifier to determine a purported file type for the electronic file;
storage for a set of rules for the purported file type; and
a scanner to determine if the electronic file conforms to the set of rules.

4. A Threat Intelligence Cloud according to claim 1, wherein the Threat Intelligence Cloud is operative to use the Virus Total Service to determine information from a plurality of traditional anti-virus solutions responsive to the electronic file a plurality of times.

5. A Threat Intelligence Cloud according to claim 4, wherein the Threat Intelligence Cloud is operative to use the Virus Total Service to determine information from a plurality of traditional anti-virus solutions responsive to the electronic file the plurality of times within a window.

6. A Threat Intelligence Cloud according to claim 4, wherein the Threat Intelligence Cloud is operative to use the Virus Total Service to determine information from a plurality of traditional anti-virus solutions responsive to the electronic file once a day.

7. A Threat Intelligence Cloud according to claim 1, wherein the information includes which of the plurality of the traditional anti-virus solutions detects the threat in the electronic file.

8. A Threat Intelligence Cloud according to claim 7, wherein the information further includes a plurality of dates on which each of the traditional anti-virus solutions detects the threat in the electronic file.

9. A Threat Intelligence Cloud according to claim 1, wherein the electronic file (305) does not include any personally identifiable information (PII).

10. A Threat Intelligence Cloud according to claim 1, wherein the electronic file includes a hash of the electronic file.

11. A Threat Intelligence Cloud according to claim 1, wherein the report is designed to be used to market the first anti-virus solution.

12. A Threat Intelligence Cloud according to claim 1, wherein the report is designed to show to a customer a comparison of the first anti-virus solution with the traditional anti-virus solutions.

13. A method, comprising:
receiving an electronic file at a Threat Intelligence Cloud, the electronic file including a threat detected by a first anti-virus solution;
testing the electronic file against a plurality of traditional anti-virus solutions by the Threat Intelligence Cloud; determining which among the plurality of traditional anti-virus solutions identify the threat in the electronic file; and
generating a report comparing when the first anti-virus solution and the plurality of traditional anti-virus solutions identify the threat within the electronic file.

14. A method according to claim 13, wherein the first anti-virus solution identifies the threat as not known to be good.

15. A method according to claim 14, further comprising:
scanning the electronic file by the first anti-virus solution;
determining a purported file type of the electronic file;
identifying a set of rules specifying when the electronic file conforms to the purported file type; and
identifying the threat as not satisfying the set of rules specifying when the electronic file conforms to the purported file type.

16. A method according to claim 13, wherein testing the electronic file against a plurality of traditional anti-virus solutions by the Threat Intelligence Cloud includes testing the electronic file against the plurality of traditional anti-virus solutions by the Threat Intelligence Cloud a plurality of times.

17. A method according to claim 16, wherein testing the electronic file against the plurality of traditional anti-virus solutions by the Threat Intelligence Cloud a plurality of times includes testing the electronic file against the plurality of traditional anti-virus solutions by the Threat Intelligence Cloud the plurality of times within a window.

18. A method according to claim 16, wherein testing the electronic file against the plurality of traditional anti-virus solutions by the Threat Intelligence Cloud a plurality of times includes testing the electronic file against the plurality of traditional anti-virus solutions by the Threat Intelligence Cloud once a day.

19. A method according to claim 16, wherein determining which among the plurality of traditional anti-virus solutions identify the threat in the electronic file includes identifying when each of the plurality of traditional anti-virus solutions first detects the threat in the electronic file.

20. A method according to claim 13, wherein the electronic file (305) does not include any personally identifiable information (PII).

21. A method according to claim 20, wherein the PII is removed from the electronic file before the electronic file is received by the Threat Intelligence Cloud.

22. A method according to claim 13, wherein receiving an electronic file at a Threat Intelligence Cloud includes receiving a hash of the electronic file at a Threat Intelligence Cloud.

23. A method according to claim 13, wherein:
determining which among the plurality of traditional anti-virus solutions identify the threat in the electronic file includes storing, in a database, which among the plurality of traditional anti-virus solutions identify the threat in the electronic file; and
generating a report comparing when the first anti-virus solution and the plurality of traditional anti-virus solutions identify the threat within the electronic file includes generating the report based on the database.

24. A method according to claim 13, wherein:
the report shows that the first anti-virus solution detected the threat in the electronic file before at least one of the plurality of traditional anti-virus solutions; and
the method further comprises forwarding the report to a customer.

25. A method according to claim 13, further comprising using the report in marketing the first anti-virus solution.

26. An article comprising a non-transitory storage medium, the non-transitory storage medium having stored thereon instructions that, when executed by a machine, result in:
receiving an electronic file at a Threat Intelligence Cloud, the electronic file including a threat detected by a first anti-virus solution;
testing the electronic file against a plurality of traditional anti-virus solutions by the Threat Intelligence Cloud;
determining which among the plurality of traditional anti-virus solutions identify the threat in the electronic file; and
generating a report comparing when the first anti-virus solution and the plurality of traditional anti-virus solutions identify the threat within the electronic file.
